(19) United States
(12) Patent Application Publication
(10) Pub. No.: US 2024/0141943 A1
(43) Pub. Date: May 2, 2024

(54) ROOFING FASTENER

(71) Applicant: Illinois Tool Works Inc., Glenview, IL (US)

(72) Inventors: Dean Grant Beardmore, Thornleigh (AU); Lachlan Lingard Hick, Olinda (AU)

(21) Appl. No.: 18/498,397

(22) Filed: Oct. 31, 2023

(30) Foreign Application Priority Data
Nov. 1, 2022 (AU) 2022903245
Oct. 31, 2023 (AU) 2023258348

(51) Int. Cl. F16B 25/10; F16B 25/00

(52) U.S. Cl. CPC F16B 25/103; F16B 25/0057; F16B 25/0084

(57) ABSTRACT

A fastener for securing a substrate to an underlying roof structure, comprising a head and an elongate shank extending therefrom, the shank having a threaded section and a drilling tip, with the drilling tip being configured to enable the fastener to be self-drilling, and wherein the head is configured to be arranged substantially flush with the substrate when the substrate is secured to the roof structure by the fastener.

### PRIORITY

This application claims priority to and the benefit of Australian Patent Application No. 2022903245, filed Nov. 1, 2022 and Australian Patent Application No. 2023258348, filed Oct. 31, 2023, the entire contents of each of which are incorporated herein by reference.

### TECHNICAL FIELD

The present disclosure relates to a fastener, and in particular a roofing fastener having a low profile head, and to a method and system for mounting a substrate to a roof structure using the fastener.

### BACKGROUND

Various roofing screws are known and used in the assembly of roof structures. Such screws include a threaded portion having a self-drilling point and a protruding head at an opposite end to the point. The protruding head is used to engage with sockets of fastening tools. Typically, the protruding head has a hexagonal profile. During installation, the screws are driven through a roofing surface, such as a sheet of corrugated steel, and into an underlying support member of the roof structure—such as a batten or purlin. At completion of installation, the heads of the screws sit substantially proud of the roof surface. The projection of the screw heads from the roof substrate brings about certain drawbacks.

With growing environmental concerns surrounding the use of fossil fuels and centralized grid-based power generation, there is an escalating desire for households and businesses alike to generate energy locally from renewable sources. Furthermore, increased prevalence of power shortfalls during peak use periods, such as heat waves, have led to an increased popularity for decentralized power sources.

Solar panels are a widely accepted local power generation mechanisms, with installations of such panels becoming commonplace in new buildings. Conventionally, these panels are supported above the roof surface by a sub-frame. Such sub-frames are undesirable due to their cost, weight, and aesthetic bulk and may not be suitable for modern roof designs. Furthermore, the presence of the sub-frames can limit the density at which the solar panels can be installed, reducing the usable area of the roof surface.

The present disclosure seeks to at least in part alleviate the above-identified problems or to offer the public with a useful alternative. The present disclosure was conceived with these short-comings in mind.

### SUMMARY

In a first aspect, the present disclosure provides a fastener for securing a substrate to an underlying support structure, comprising: a head and an elongate shank extending therefrom, the shank having a threaded section and a drilling tip, with the drilling tip being configured to enable the fastener to be self-drilling; and wherein the head is configured to be arranged substantially flush with the substrate when the substrate is secured to the support structure by the fastener.

In a further aspect, the present disclosure provides a fastener for securing a substrate to an underlying roof structure, comprising: a head and an elongate shank extending therefrom, the shank having a threaded section and a drilling tip, with the drilling tip being configured to enable the fastener to be self-drilling; and wherein the head is configured to be arranged substantially flush with the substrate when the substrate is secured to the roof structure by the fastener.

The head may have a generally domed shape and may be of greater diameter than the shank, with an upper surface thereof defining an uppermost boundary of the fastener. The head may further include a depression on an undersurface thereof such that a washer may be at least partially accommodated within the depression of the head. The head may include a cavity for receiving a tool to rotationally drive the fastener.

In some embodiments, the threaded section of the shank may comprise a buttress thread. The buttress thread may have a leading thread angle of about 7 degrees and a trailing thread angle of about 30 degrees. Alternatively, the threaded section of the shank may comprise a symmetric thread. The symmetric thread may have a thread angle of about 60 degrees wherein each of the leading and trailing thread angles are about 30 degrees. The threaded section of the shank may also comprise an upper thread portion that is spaced apart from a lower thread portion. In some embodiments, a plurality of longitudinal projections is provided between the upper and lower thread portions of the shank, the projections being configured to engage the substrate. The upper thread portion may include a diameter that reducingly tapers from the head towards the lower threaded portion.

The drilling tip of the shank may include a conical reduction. The drilling tip may include a longitudinally extending cutting edge. The longitudinal cutting edge at least partially defines a cut-out within the shank.

In some embodiments, the fastener is an anti-corrosive fastener.

According to a second aspect, the present disclosure provides a method of mounting substrate to a support structure of a building, the method including: positioning a substrate in abutment with the support structure; and securing the substrate to the support structure with a fastener by driving the fastener through the substrate such that a head of the fastener is disposed substantially flush with the substrate.

According to a further aspect, the present disclosure provides a method for installing a solar panel upon a roof structure, the method including securing a substrate to the roof structure with a fastener; and mounting the solar panel to the substrate over the fastener, with a head of the fastener being disposed substantially flush with the substrate, such that the panel can abut directly against the substrate.

In some embodiments, the solar panel may be a flexible solar panel permitting the solar panel to be affixed to a curved substrate. Mounting the solar panel to the substrate may include applying an adhesive to one of the substrate and the panel and positioning the solar panel upon the substrate.

According to a third aspect, the present disclosure provides a system for mounting solar panels to a roof structure, the system comprising: a substrate configured to extend over the roof structure, a plurality of fasteners configured to secure the substrate to the roof structure and at least one solar panel configured to be laid in abutting arrangement with the substrate, wherein each of the fasteners comprises a head that is configured to be arranged substantially flush with the substrate, such that when mounted to the substrate, the solar panels abut directly against the substrate and extend over the fasteners.

The fasteners may include a drilling tip, with the drilling tip being configured to enable each of the fasteners to be self-drilling. The head of each of the fasteners may have a generally domed shape and be of greater diameter than the shank, with an upper surface thereof defining an uppermost boundary of the fastener. The solar panels may be flexible solar panels permitting the solar panels to be affixed to a curved substrate.

### BRIEF DESCRIPTION OF THE DRAWINGS

The present disclosure will now be described, by way of non-limiting example only, with reference to the accompanying drawings.

FIG. 1 shows an example solar panels being installed onto a roof using low profile roofing fasteners in accordance with one example embodiment of the present disclosure.

FIG. 2 is a flow chart showing a process for installing solar panels on a roof using the low profile fasteners in accordance with one example embodiment of the present disclosure.

FIG. 3 is a side view of a low profile roofing fasteners in accordance with one example embodiment of the present disclosure.

FIG. 4 is a perspective view of the low profile roofing fastener of FIG. 3.

FIG. 5 is an alternate perspective view of the low profile roofing fastener of FIG. 3.

FIG. 6 is a perspective view of a low profile fastener in accordance with an example embodiment of the present disclosure.

FIG. 7 is a perspective showing the low profile fastener of FIG. 6 in-situ securing a substrate to an underlying support structure.

FIG. 8 is an alternate perspective view of the low profile fastener of FIG. 6 in-situ securing the substrate to the support structure.

### DETAILED DESCRIPTION

While the systems, devices, and methods described herein can be embodied in various forms, the drawings show, and the specification describes certain exemplary and non-limiting embodiments. Not all components shown in the drawings and described in the specification can be required, and certain implementations can include additional, different, or fewer components. Variations in the arrangement and type of the components; the shapes, sizes, and materials of the components; and the manners of connections of the components can be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

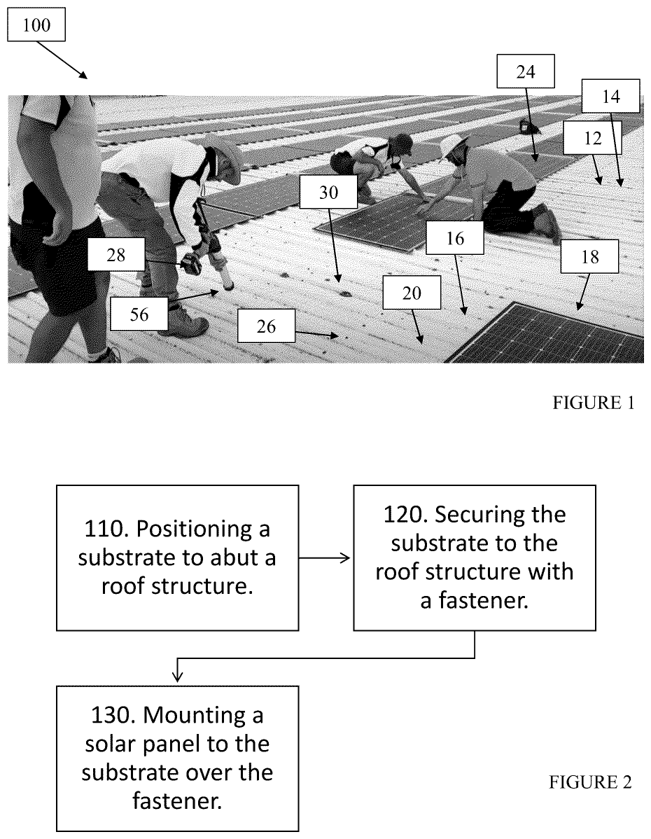

FIG. 1 shows a system 100 for installing a plurality of solar panels 24 atop a support structure 14 of a roof, in accordance with an aspect of the present disclosure. The system includes a plurality of fasteners 10 that are used for securing a roof substrate 12 to an underlying roof structure 14. The substrate 12 provides a cover that extends over the roof structure 14. As shown in FIG. 1, the roof substrate 12 is a corrugated sheet. It is understood, however, that the substrate 12 need not be corrugated and can, for example, be substantially planar. The fasteners 10 are installed atop crests 16 or within valleys 18 of the corrugations. The substrate 12 may comprise a plurality of sheets that are arranged in a stitched or lapped 20 fashion, with the fasteners 10 being installed where adjacent sheets join so as to interconnect said sheets together to form a substantially continuous substrate 12. The fasteners 10 are installed into the substrate 12 such that they are substantially flush with an upper surface of the substrate 12.

The fasteners 10 are configured to be installed by a hand-held powered driver 28 such as a drill. The driver 28 has an attachment bit 56 that is configured to rotatably engage with the fastener 10. Alternatively, the fasteners 10 could be installed by a manual driver such as a screwdriver.

The solar panels 24 are laid directly onto the roof substrate 12. By this, it is understood that the solar panels 24 do not require a sub-frame or other underlying supporting assembly. Specifically, the solar panels 24 are arranged in abutment with the substrate 12 and mounted thereto, preferably by adhesive 30. Preferably, the solar panels 24 are flexible panels, to permit installation upon curved substrates 12. The panels 24 are installed such that they extend atop the fasteners 10. The adhesive 30 is applied to either one of an undersurface of the panel 24 or to the exposed upper surface of the substrate 12. The adhesive 30 is preferably a silicone based adhesive, which provides ultraviolet light and water resistance so being ideal for installation on a roof structure 14 exposed to weather. Alternative adhesives may also be used, including polyurethanes or any number of solvent-based, water-based or bonding adhesives as is suitable for the location of the roof structure 14.

While FIG. 1 shows the panels 24 as being laid in spaced apart rows, it is understood that this is not necessary, and indeed may not be preferable. Rather, an advantage of the present disclosure lies in the ability for the panels 24 to be laid in a substantially continuous array, with little to no spacing between adjacent rows of panels 24, or between neighboring panels 24 within each row.

A method 101 of installing a substrate to a support structure of a building using the system 100 will now be described in reference to FIG. 2.

In a step 110, a substrate 12 is positioned atop a structure 14. The step of positioning the substrate 12 atop the support structure 14 may comprise lifting the substrate 12 from a ground surface and positioning the substrate 12 atop the supporting structure 14. The supporting structure 14 may be a timber truss-like structure, comprising members including purlins and battens. Several sheets of substrate 12 may need to be lifted and positioned atop the supporting structure 14 in an overlapping arrangement.

In a following step 120, the substrate 12 is secured to the support structure 14 with at least one fastener 10. Preferably, a plurality of said fasteners 10 are used, with the fasteners 10 being arranged in rows across the length of the support structure 14. The rows are spaced apart across a width of the support structure 14, with the fasteners 10 being driven through the substrate 12 and into the underlying support structure 14. Preferably, the fasteners 10 are rotatably driven into the support structure 14 using a hand-held power tool or driver 28. The fasteners 10 are driven into the substrate, such that the fastener 10 is seated within the substrate 12, and sits substantially flush with the upper surface thereof.

The applicant has determined that the method 101 may have particular application in the roofing industry, with the support structure 14 being a roof structure and the substrate 12 being a roof covering such as corrugated iron sheets. In such applications, a further step 130 may follow, in which at least one solar panel 24 is mounted to the roofing substrate 12, over the fastener 10. As shown in FIG. 1, the at least one solar panel 24 is preferably one of an array of solar panels 24 installed upon the substrate 12. Advantageously, the system 100 enables an increased density of solar panels 24 to be installed for a given roof area. This is because the solar panels 24 are directly mounted to the roof substrate 12, without the need for a sub-frame which necessitates greater inter-panel spacing. In particular, the panels 24 are mounted to the substrate 12 by the use of adhesive. In use, the panels 24 extend over and above the fasteners 10, which lie beneath. This is enabled because the fasteners 10 sit substantially flush with the substrate—thereby permitting the substantially planar panels to lie flat and smooth atop the substrate 12 and fasteners 10. Beneficially, because the panels 24 are in direct contact with the substrate 12, there is a greater surface area to facilitate a thermal path for heat from the solar panels 24 to be dissipated into the substrate 12 across the roof surface. The fasteners 10 may also provide a path for the heat transfer into the substrate 12.

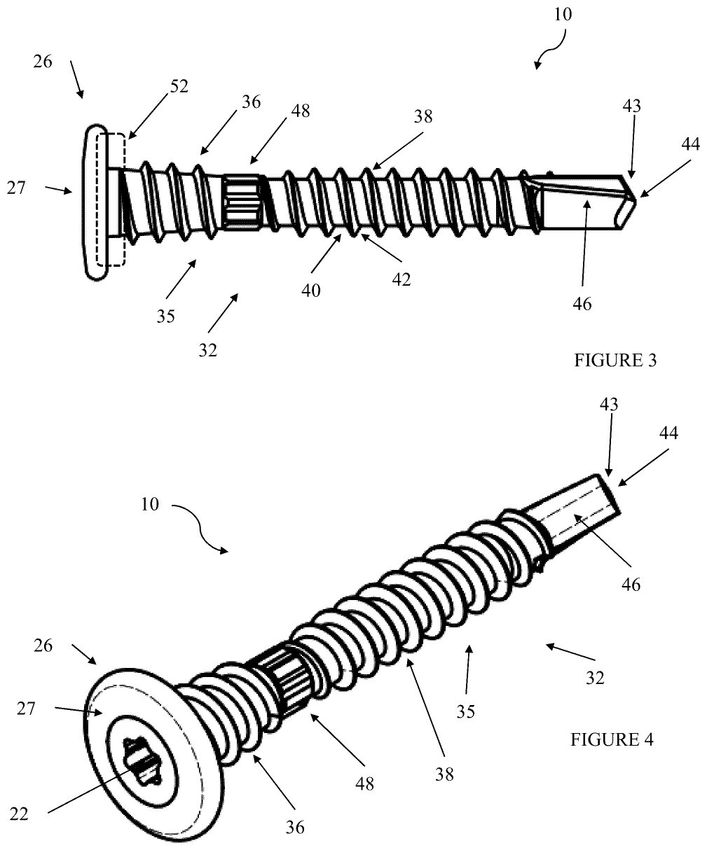

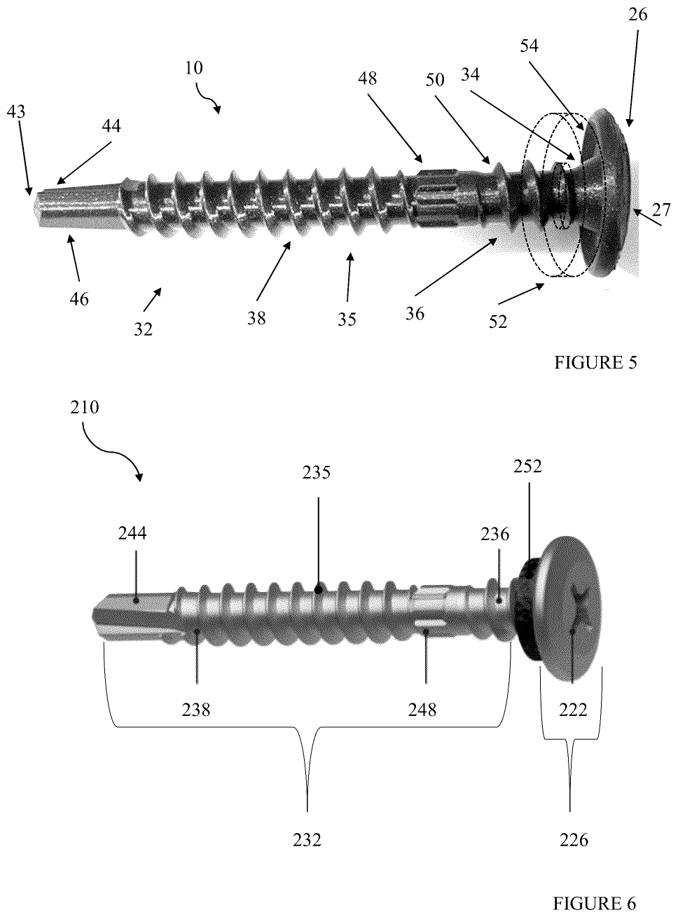

A preferred embodiment of the fastener 10 will now be described in detail with reference to FIGS. 3, 4, and 5.

FIGS. 3, 4, and 5 show a preferred form of fastener 10 in the form of a roofing screw. The fastener 10 has a head 26 and an elongate shank 32 extending from it. The head 26 is a low-profile head. What is meant by this is that the head 26 sits substantially flush with the shank below and does not overtly project upwardly therefrom. In the embodiment shown, the head 26 includes a dome shaped upper surface 27. It is understood that other fastener head shapes are also contemplated and may also be used with different embodiments of the fastener 10, such as button, pan, mushroom, truss, fillister, binding or round heads. This is because each such configuration of the head 26 similarly provides a substantially flush fitment with respect to the substrate 12 into which they are fastenable. Put differently, the upper surface 27 of the head 26 of the fastener 10 lies substantially in a common plane with that of the substrate 12. In yet a further alternative embodiment, the fastener 10 may instead comprise a countersunk head, wherein the fastener 10 sits flush or below the substrate 12 after fastening.

A cavity 22 is provided within the upper surface 27 of the head. The cavity 22 extends downward from the head 26 and into the shank 32 there below. The cavity 22 is configured to receive the attachment bit of the driving tool 28. As shown in FIG. 3, the cavity 22 may be shaped to accommodate and engage with a 6-point star shaped male tool, such as a Torx bit 56. Alternatively, the cavity 22 may subsist in a 4-pointed star shape capable of receiving a Philips headed bit, or any other shape for receiving a complementary bit of the tool 28 such that the tool is rotatably engaged therewith. Non-limiting examples include common tools and security bits.

As best shown in FIG. 2, the elongate shank 32 of the fastener 10 includes a threaded section 35. In the illustrated embodiment, the threaded section 35 includes an upper threaded portion 36 and a lower threaded portion 38. The lower threaded portion 38 is disposed towards the tip or free end of the shank 32. The upper threaded portion 36 is disposed towards the head 26, and is spaced from the lower threaded portion 38. In the embodiments shown, the thread of each of these portions 36, 38 is a right-handed screw thread, although it is to be understood that other thread types would be suitable.

Turning now to FIG. 4, it can be seen that the threaded section 35 is provided as a symmetric thread. What is meant by this is that each of the threaded portions 36 and 38 have a symmetric threaded profile, comprising equal angle flanks. In the embodiment shown, the thread angle is 60 degrees, being 30 degrees on either flank 40 and 42. A buttress thread may also be used, wherein there exists a leading thread angle 40 and a trailing 42 thread angle that is different from the leading thread angle 40. In an alternate embodiment, the leading angle 40 is 7 degrees, and the trailing angle 42 is 30 degrees. Each of the symmetric or buttress thread angles 40, 42 enable a reduction in the distortion of the roofing substrate 12 during fastening, and provide a stronger and more robust connection to the substrate 12, with a reduced likelihood of the threads 40, 42 pulling out of the substrate 12. This is an important aspect as most roofing substrates 12 are thin and prone to the issue of pulling out. It is understood that the above angles are optimal angles that the applicant has developed through experimental trials and/or simulations. It is also contemplated that other angles, such as a symmetric thread angle of between 55 and 65 degrees, or buttress leading angles of, for example, between 5 and 10 degrees would also be suitable. Similarly, it is contemplated that buttress trailing angles of between 25 and 35 degrees could alternatively be used.

Optionally, the elongate shank 32 can also include a taper 34 increasing the diameter of the shank 32 immediately beneath the undersurface of, and increasing toward, the head 26. This is best shown in FIG. 3. The taper 34 is best suited for embodiments of the fastener 10 in which the cavity 22 is a comparatively large cavity, reducing the amount of material within the head 26 and shank 32. The taper 34 thus provides a way of increasing a wall thickness at an upper head of the shank 32, to increase a strength thereof. The taper 34 is a reducing taper—that is the diameter of the shank decreases along the length thereof, in a direction from the head 26 toward the tip or free end of the shank 32.

The fastener 10 also includes a drilling tip 44. The drilling tip 44 is provided at the distal or lower end of the shank 32 (with the opposing proximal or upper end of the shank 32 being proximate the head 26). The drilling tip 44 is configured to enable the fastener 10 to be fastened to the roof substrate 12 directly and in any position. Specifically, the drilling tip 44 of the fastener 10 pierces the roofing substrate 12, providing a pilot hole, before the following lower threaded portion 38 of the shank 32 enters through the pilot hole. This enables the fastener 10 to be rotationally driven downwards into the roofing structure 14, providing a ‘self-drilling’ or ‘self-tapping’ effect.

With specific reference to the embodiment shown in the Figures, the drilling tip 44 incorporates a “TEKs” type tip that includes conical reduction 43 in the diameter of the shank 32 towards the distal end. This reduction aids in the speed of the initial piercing of the substrate 12, and reduces wandering of the tip 44, whereby the tip 44 may otherwise unintentionally move or deviate when attempting to actuate the fastening of the fastener 10. The drilling tip 44 is further equipped with a longitudinally extending cutting edge 46, which cuts the roofing substrate 12 as the fastener 10 is rotationally driven. This cutting edge 46 at least partially defines a cut-out within the lower end of the shank 32. As shown, this cut-out is V-shaped. Other geometries of drilling tip are also contemplated—for example a “ZIPs” type tip.

Best shown in FIG. 3, a plurality of longitudinal projections 48 is provided between the upper 40 and lower 42 thread portions. The longitudinal projections 48 project along the length of the shank 32, or, put differently, are substantially transverse to the threads of the threaded portions 36 and 38. The longitudinal projections 48 act on the roofing substrate 12 to increase the diameter of the hole made by the fastener 10 upon fastening, and thus prevent scratching of the shank 32 of the fastener 10. In turn, this can improve the anti-corrosive properties of the fastener 10, because any coating or coatings that are applied thereto would otherwise be damaged or reduced.

An increased diameter 50 around the shank 32 is also provided between the upper 36 and lower 38 thread portions, separate to the plurality of longitudinal projections 48. The increased diameter 50 engages the roofing substrate 12 during fastening assisting to seal the puncture in the substrate 12 caused by the fastener 10, by creating a tighter seal with the shank 32. The increased diameter 50 further assists in retaining the substrate to the fastener 10 and roof structure 14, and prevents the roof substrate 12 moving along the shank 32 when, for example, it is stepped on by an installer during installation of the substrate 12.

Preferably, when used for the installation of the panels 24 atop a roof structure, the fasteners 10 are fitted with a washer 52. The washer is represented in dotted outline on FIGS. 3, 4, and 5. The purpose of the washer 52 is to seal the roofing substrate 12 at the entry point of the fastener 10. Additionally, the washer 52 can cater for variations in the upper surface of the roof substrate 12, such as the crests 16 and valleys 18 of a corrugated roofing substrate 12. To facilitate use with the washer 52, fastener 10 features a depression 54 on the undersurface of the head 26. The depression 54 is annular in shape and is sized to accept or engage a washer 52, and retain said washer 52 in place during fastening. It is contemplated that the washer 52 be made from ethylene propylene diene monomer (EPDM) rubber. Other resilient materials, such as other rubbers or polymeric materials are also suitable, permitting the washer 52 to conform to the shape of the roof substrate 12 upon fastening, and thus provide a seal at the fasteners 10 point of entry.

The fastener 10 is an anti-corrosive fastener. This anti-corrosive property can be provided by several different manners. For example, the fastener 10 may be anti-corrosive by way of the nature of the material from which it is formed. In such embodiments, it is contemplated that the fastener 10 is formed from stainless steel. Alternatively, the fastener 10 may be formed from other inherently corrosion resistant materials, such as galvanized steel. The fastener 10 can alternatively/additionally be provided with an anti-corrosive coating. The coating may include, for example, a mechanically deposited zinc tin alloy, passivation applied zinc tin alloy; an aluminum filled polyester coating; or any combination of these.

An alternate embodiment of the present disclosure in the form of fastener 210 will now be described with reference to FIGS. 6, 7, and 8. For clarity, similar reference numerals will be used to describe analogous features.

Fastener 210 is generally similar to fastener 10 and may include any combination of the features thereof. Notably, however, the shank 232 of fastener 210 has a shorter length compared to that of fastener 10, such that fastener 210 is particularly suitable for use as a cladding screw, for securing cladding 212 to underlying support structure 214 of a building.

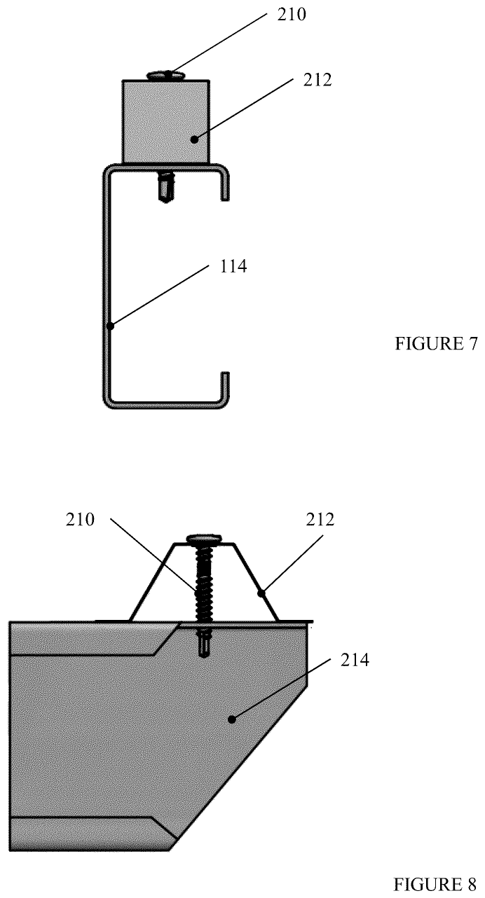

The fastener 210 retains the low-profile head 226, so as to rest substantially flush against the substrate 212 in-situ. It is understood, however, that the term “substantially flush” does not require the head 126 to rest parallel with the substrate. Rather, what is preferred is that the head 126 projects only a minimum distance outwardly therefrom. For example, best shown in FIGS. 7 and 8, the head 126 may project by about 3 mm from the upper corrugation of cladding 212. As shown, the head 126 includes a cavity 122 that is shaped to receive a Phillips-head driver. It is understood, however, that the cavity 122 may be shaped differently to suit other drivers, such as, for example, Torx drivers.

The shank 232 of fastener 210 includes a threaded portion 235 comprising upper thread portion 236 and lower thread portion 238. The upper thread portion is configured to provide a clamping force to prevent water entry into the underlying structure and overdrive of fastener 210. The shank 232 also includes a plurality of longitudinal projections 248 is provided between the upper 236 and lower 238 thread portions. Together, the longitudinal projections 248 provide a guard portion that acts on the substrate 212 to increase the diameter of the hole made by the fastener 210 upon fastening, and thus prevent scratching of the shank 232 of the fastener 210. In turn, this can improve the anti-corrosive properties of the fastener 210, by minimizing damage to any anti-corrosive coating or coatings that are applied thereto. In other embodiments, it is understood that the guard portion may be obviated to allow for further shortening of the shank 232, with the thread portion 235 instead being provided as a singular or integral portion.

The fastener 210 includes a drilling tip 244 at the distal end of the shank 232. The drilling tip 244 is configured to enable the fastener 210 to be rotationally driven downwards into the support structure 214, providing a ‘self-drilling’ or ‘self-tapping’ effect. As shown, the tip 244 is a TEKs-type tip, however it is understood that other self-drilling tips including ZIPS type pointed tips are also contemplated.

Summarily, it is understood that the fastener as described herein provides a low-profile alternative to conventional screws that typically include a protruding head to engage with a socket of a hand-held driving tool. Specifically, the fastener instead includes a substantially flat head with a recessed cavity that is configured to receive and rotatably engage with the hand-held driving tool. Advantageously, the recessed cavity enables the head of the fastener to be low-profile, and sit substantially flush with the substrate to which the fastener is fitted. This is particularly useful for roofing applications and may, for example, enable the installation of solar panels atop said substrate, because the panels can be laid directly there above, instead of having to be spaced apart to make room for the protruding heads of conventional fasteners. In turn, the overall density of panels atop the roof structure can therefore be increased.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above described exemplary embodiments.

### LEGEND

| | |
|---|---|
| 10 | Fastener |
| 12 | Substrate |
| 14 | Support Structure |
| 16 | Corrugation crests |
| 18 | Corrugation valleys |
| 20 | Corrugation stitching |
| 22 | Tool cavity |
| 24 | Solar panel |
| 26 | Head |
| 27 | Upper surface |
| 28 | Driver |
| 30 | Adhesive |
| 32 | Elongate shank |
| 34 | Taper |
| 35 | Threaded section |
| 36 | Upper thread portion |
| 38 | Lower thread portion |
| 40 | Leading thread angle |
| 42 | Trailing thread angle |
| 43 | Conical reduction |
| 44 | Drilling tip |
| 46 | Cutting edge |
| 48 | Longitudinal projections |
| 50 | Shank diameter increase |
| 52 | Washer |
| 54 | Depression |
| 56 | Attachment bit |
| 100 | System |
| 101 | Method |
| 110 | Positioning step |
| 120 | Securing Step |
| 130 | Mounting Step |
| 210 | Fastener |

1. A fastener for securing a substrate to an underlying support structure, the fastener comprising:
a head; and
an elongate shank extending from the head, the shank having a threaded section and a self-drilling drilling tip, and wherein the head is configured to be substantially flush with the substrate when the substrate is secured to the support structure by the fastener.

2. The fastener of claim 1, wherein the head has a dome shape and has a greater diameter than the shank, wherein the head has an upper surface defining an uppermost boundary of the fastener.

3. The fastener of claim 1, wherein the head includes an undersurface that defines a depression such that a washer is at least partially receivable within the depression.

4. The fastener of claim 1, wherein the head defines a cavity configured to receive a tool to rotationally drive the fastener.

5. The fastener of claim 1, wherein the threaded section of the shank comprises a buttress thread.

6. The fastener of claim 1, wherein the threaded section of the shank comprises a symmetric thread.

7. The fastener of claim 1, wherein the threaded section of the shank comprises an upper thread portion that is spaced apart from a lower thread portion.

8. The fastener of claim 7, which includes a plurality of longitudinal projections between the upper and lower thread portions of the shank, the projections configured to engage the substrate.

9. The fastener of claim 7, wherein the upper thread portion has a diameter that reducingly tapers from the head towards the lower threaded portion.

10. The fastener of claim 1, wherein the drilling tip of the shank includes a conical reduction.

11. The fastener of claim 1, wherein the drilling tip includes a longitudinally extending cutting edge.

12. The fastener of claim 11, wherein the longitudinal cutting edge at least partially defines a cut-out within the shank.

13. The fastener of claim 1, which is formed from an anti-corrosive material.

14. A fastener for securing a substrate to an underlying support structure, the fastener comprising:
a head having a dome shape and an upper surface defining an uppermost boundary of the fastener, the head including an undersurface that defines a depression such that a washer is at least partially receivable within the depression;
an elongate shank extending from the head, the shank having a threaded section and a self-drilling drilling tip, wherein the threaded section of the shank comprises an upper thread portion that is spaced apart from a lower thread portion, wherein the upper thread portion has a diameter that reducingly tapers from the head towards the lower threaded portion, wherein the drilling tip includes a conical reduction, and wherein the drilling tip includes a longitudinally extending cutting edge that at least partially defines a cut-out within the shank; and
a plurality of longitudinal projections between the upper and lower thread portions of the shank, the projections configured to engage the substrate,
wherein the head has a greater diameter than the shank, and
wherein the head is configured to be substantially flush with the substrate when the substrate is secured to the support structure by the fastener.

15. The fastener of claim 14, wherein the head defines a cavity configured to receive a tool to rotationally drive the fastener.

16. The fastener of claim 14, wherein the threaded section of the shank comprises a buttress thread.

17. The fastener of claim 14, wherein the threaded section of the shank comprises a symmetric thread.
